(19) United States
(12) Patent Application Publication
(10) Pub. No.: US 2023/0077780 A1
(43) Pub. Date: Mar. 16, 2023

(54) AUDIO COMMAND CORROBORATION AND APPROVAL

(71) Applicant: INTERNATIONAL BUSINESS MACHINES CORPORATION, (US)

(72) Inventors: Clement Decrop, Arlington, VA (US); Jacob Thomas Covell, New York, NY (US); Manus Kevin McHugh, Colorado Springs, CO (US); Zachary A. Silverstein, Georgetown, TX (US)

(21) Appl. No.: 17/447,929

(22) Filed: Sep. 16, 2021

(51) Int. Cl. H04L 29/06; G06F 3/16; H04L 29/08; G06N 20/00

(52) U.S. Cl. CPC H04L 63/1425; G06F 3/16; H04L 67/125; G06N 20/00

(57) ABSTRACT

Embodiments of the present disclosure include a method for preventing attacks of audio-based virtual assistants, a system, and a computer program product. One embodiment of the method may comprise receiving an audio command at a first Internet-of-Things (IoT) device in a location, analyzing the audio command using one or more other IoT devices in the location, and performing an ameliorative action in response to an anomaly identified during the analyzing. The analyzing may include comparing the audio command received by the first IoT device to audio received by the one or more other IoT devices. The comparing may comprise computing a relative volume level. The comparing may further comprise computing an audio delay.

### BACKGROUND

The present disclosure relates to computer security, and more specifically, to computer security via audio command corroboration and approval.

The development of the EDVAC system in 1948 is often cited as the beginning of the computer era. Since that time, computer systems have evolved into extremely complicated devices. Today's computer systems typically include a combination of sophisticated hardware and software components, application programs, operating systems, processors, buses, memory, input/output devices, and so on. As advances in semiconductor processing and computer architecture push performance higher and higher, even more advanced computer software has evolved to take advantage of the higher performance of those capabilities, resulting in computer systems today that are much more powerful than just a few years ago.

One application of these new capabilities is the Internet-of-Things (IoT). The IoT generally refers to a network of IoT devices e.g., devices, vehicles, signs, buildings, and other items embedded with electronics, software, sensors, microphones, speakers, and/or physical actuators, plus network connectivity that may enable these objects to collect and exchange data with other IoT devices and/or computer systems. The IoT allows objects to be sensed or controlled remotely across network infrastructure, creating opportunities for more direct integration of the physical world into computer-based systems, and resulting in improved efficiency, accuracy, and economic benefits, in addition to reduced human intervention. When IoT devices include sensors and actuators, the technology becomes an instance of the more general class of cyber-physical systems, also encompassing technologies such as smart grids, virtual power plants, smart homes, intelligent transportation, and smart cities. Each thing in such a system may be uniquely identifiable through its embedded computing system, and may be able to interoperate within the network infrastructure.

### SUMMARY

According to embodiments of the present disclosure, a method for preventing attacks of audio-based virtual assistants. One embodiment may comprise receiving an audio command at a first Internet-of-Things (IoT) device in a location, analyzing the audio command using one or more other IoT devices in the location, and performing an ameliorative action in response to an anomaly identified during the analyzing. The analyzing may include comparing the audio command received by the first IoT device to audio received by the one or more other IoT devices. The comparing may comprise computing a relative volume level. The comparing may further comprise computing an audio delay.

According to embodiments of the present disclosure, a system for preventing beam-form attacks of audio-based virtual assistants. One embodiment may comprise a processing unit and a memory coupled to the processing unit and storing instructions thereon. The instructions, when executed by the processing unit, may perform a method for preventing attacks of audio-based virtual assistants, comprising receiving an audio command at a first Internet-of-Things (IoT) device in a location, analyzing the audio command using one or more other IoT devices in the location, and performing an ameliorative action in response to an anomaly identified during the analyzing. The analyzing may include comparing the audio command received by the first IoT device to audio received by the one or more other IoT devices. The processing unit and the memory may be configured into a cloud computing environment.

According to embodiments of the present disclosure, a computer program product for preventing beam-form attacks of audio-based virtual assistants. The computer program product may comprise a computer readable storage medium having program instructions embodied therewith. The program instructions may be executable by a processor to cause the device to perform a method comprising receiving an audio command at a first Internet-of-Things (IoT) device in a location, analyzing the audio command using one or more other IoT devices in the location, and performing an ameliorative action in response to an anomaly identified during the analyzing. The analyzing may include comparing the audio command received by the first IoT device to audio received by the one or more other IoT devices.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates an embodiment of a data processing system suitable for use in a cloud environment, consistent with some embodiments.

FIG. 2 illustrates a cloud environment, consistent with some embodiments.

FIG. 3 illustrates a set of functional abstraction layers provided by cloud computing environment, consistent with some embodiments.

FIG. 4 illustrates an example IoT system, consistent with some embodiments.

FIGS. 5A-5B are a flow chart illustrating one method of operating the system of FIG. 4.

FIG. 6A illustrates an example AI model, consistent with some embodiments.

FIG. 6B depicts one embodiment of a AI model training method.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to computer security; more particular aspects relate to computer security via audio command corroboration and approval. While the present disclosure is not necessarily limited to such applications, various aspects of the disclosure may be appreciated through a discussion of various examples using this context.

Many IoT devices are adapted to respond to voice commands. Many IoT devices may also serve as inputs to virtual assistants (VAs) operating in a cloud-computing environments. Those VAs, in turn, may control other IoT devices throughout a home or workspace, and may have access to sensitive information.

While voice command input has many advantages, some voice-controlled IoT devices (and, thus, their associated VAs) will respond to inputs techniques other than the authorized user's voice. These other input techniques are not necessarily evident to nor desired by the authorized owner(s) of that IoT device, the VA, and/or the locations in which those IoT devices operate. For example, researchers at the University of Michigan and the University of Electro-Communications in Tokyo have used low power laser beams to direct polarized light at different intensities onto the microphones of certain IoT devices. In that demonstration, changing intensities of the laser's light caused the IoT devices to react as if they were hearing actual sounds. That is, researchers found that these “light commands” could be used to activate and to issue commands to the IoT devices and their associated VAs.

While this “light command” technique raises important security issues for all IoT devices and VAs, it can be a particular problem for those IoT devices (and associated VAs) that are used to control access to physical locations, such as a home or workspace. For example, a group of IoT devices may be connected to a VA, which in turn, may be given authority to remotely unlock the entry doors to a workspace. A malicious actor in this scenario may be able to defeat the security system, and thus gain access to the workspace, by shining a laser through a window (i.e., from outside of the workspace), and then issuing a “light command” to the VA. More concerning, in many applications, the interior IoT devices attacked in this scenario are often configured with lower levels of security than are exterior IoT devices, as it is often assumed that access to the workspace is controlled. Accordingly, one feature and advantage of this disclosure is improved authentication/authorization for audio (e.g., spoken) commands received via IoT devices, as well as for their associated VAs in view of the proxy authority they may acquire.

Some embodiments of this disclosure may utilize previously-measured volume levels of overheard audio from adjacent IoT devices to train/customize (generically “train”) an artificial intelligence (AI) model for a particular location to detect anomalies. The trained AI model may detect the anomalies by generating a predictive classification score for a likelihood that a particular audio command is part of an attack, including a light command attack. Additionally or alternatively, some embodiments of this disclosure may generate a consensus score to differentiate between authorized and unauthorized commands. These embodiments may include a system and method in which other, nearby IoT devices (e.g., physically close enough to hear the same commands) in a group of IoT devices may be used to evaluate commands received by their sibling IoT devices. This evaluation may include using statistics about the overheard/overlap audio, including relative volumes and audio delays, to detect anomalies. An associated VA may use the resulting evaluation to determine whether to accept the command or whether to take other ameliorative actions.

The AI model in some embodiments may recognize expected patterns/noise levels of commands spoken within a particular location. These embodiments may include a system and method in which a VA and “n” number of physically nearby IoT devices may generate an expected pattern of delays and/or noise levels for overhead audio commands issued within a controlled space. For example, an audio command spoken in one room of a home will normally be heard at 100% volume by a first IoT device, 75% volume by a second audio device, and 25% volume by a third IoT device. These embodiments may further include calculating and using predictive noise levels e.g., a predictive analytics method where a given voice command will have a series of predicted volume levels across multiple IoT devices. This predictive analytics may be further customized based on its content. For example, commands to “unlock a door” may normally be issued in a first room, while commands to “turn on a television” may normally be issued in a second room.

The ameliorative action in some embodiments may include utilizing an alert system to notify an owner about possible attacks. These embodiments may include an alerting and restriction mechanism to escalate audio commands (e.g., to delay execution of the command until the owner approves it), where statistically significant differences in expected volume levels and/or patterns of audio delay may be observed against predicted expected values by the AI model. These embodiments may further include a classification system e.g., a classification method to notify the user of an attempted, or possibly attempted, light command attack.

In some embodiments, a secure IoT device may be placed in/near a secured location, but in a more-secure location than the other IoT device(s) (e.g., a locked box within a room in the location) to listen for voice commands. These paired units (i.e., the primary IoT device(s) and the secondary IoT device in the locked box) may be used to determine if a command was authorized. For example, before the VA responds to a particular voice command, the VA can ask “does any other IoT device hear that?” If the answer is “no,” then the VA may assume an intrusion is taking place. If the answer is “yes,” then the VA may perform relative volume and timing analysis to determine whether the command matches an expected signature.

Some aspects of this disclosure may be desirable because they can scale in several dimensions. For example, multiple IoT devices can be placed within a secured space (e.g., a home or workplace) to better differentiate authorized commands from unauthorized commands. Further, some embodiments may be integrated with site security systems, badge access controls, cameras, and/or intruder alarm settings being set to “away” mode. For example, a system consistent with some embodiments may require a relatively lower level of confidence in a command when authorized users are known to be on site, and a relatively higher level of confidence when all of the authorized users are believed to be away. Additionally, some embodiments may be desirable even in applications where security is less important, as the consensus system may still improve the accuracy of the IoT system to perceived commands.

### Data Processing System

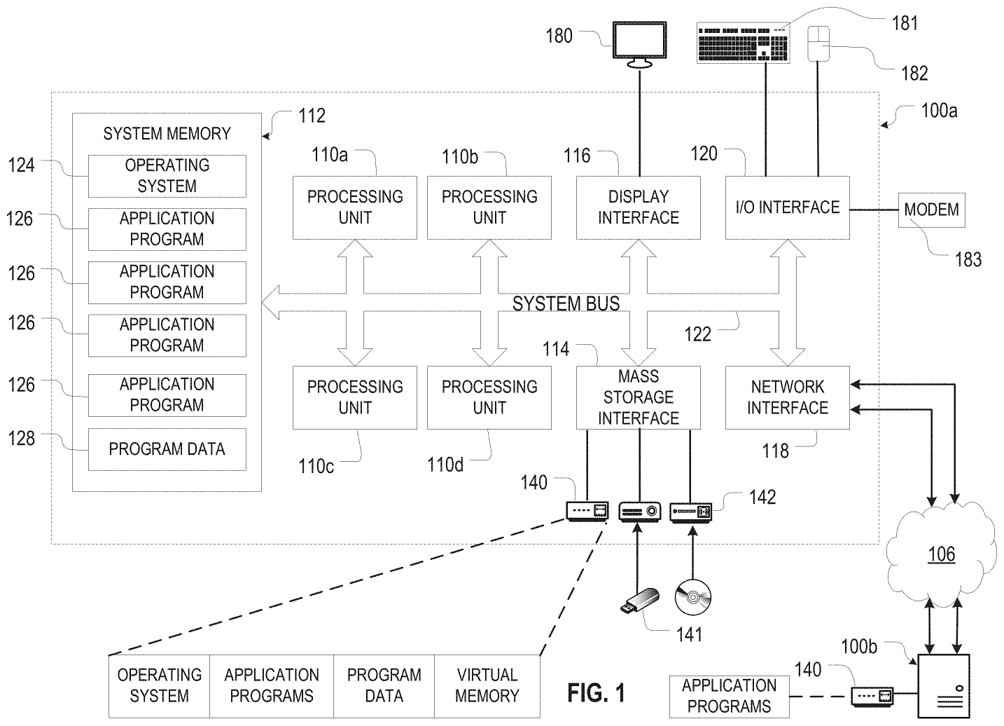

FIG. 1 illustrates one embodiment of a data processing system (DPS) 100a, 100b (herein generically referred to as a DPS 100), consistent with some embodiments. FIG. 1 only depicts the representative major components of the DPS 100, and those individual components may have greater complexity than represented in FIG. 1. In some embodiments, the DPS 100 may be implemented as a personal computer; server computer; portable computer, such as a laptop or notebook computer, PDA (Personal Digital Assistant), tablet computer, or smartphone; processors embedded into larger devices, such as an automobile, airplane, teleconferencing system, appliance; smart devices; or any other appropriate type of electronic device. Moreover, components other than or in addition to those shown in FIG. 1 may be present, and that the number, type, and configuration of such components may vary.

The data processing system 100 in FIG. 1 may comprise a plurality of processing units 110a-110d (generically, processor 110 or CPU 110) that may be connected to a main memory 112, a mass storage interface 114, a terminal/display interface 116, a network interface 118, and an input/output (“I/O”) interface 120 by a system bus 122. The mass storage interfaces 114 in this embodiment may connect the system bus 122 to one or more mass storage devices, such as a direct access storage device 140, a USB drive 141, and/or a readable/writable optical disk drive 142. The one or more direct access storage devices 140 may be logically organized into a RAID array, which in turn, may be managed by a RAID controller 115 in e.g., the mass storage interface 114, by software executing on the processor 110, or a combination of both. The network interfaces 118 may allow the DPS 100a to communicate with other DPS 100b over a network 106. The main memory 112 may contain an operating system 124, a plurality of application programs 126, and program data 128.

The DPS 100 embodiment in FIG. 1 may be a general-purpose computing device. In these embodiments, the processors 110 may be any device capable of executing program instructions stored in the main memory 112, and may themselves be constructed from one or more microprocessors and/or integrated circuits. In some embodiments, the DPS 100 may contain multiple processors and/or processing cores, as is typical of larger, more capable computer systems; however, in other embodiments, the computing systems 100 may only comprise a single processor system and/or a single processor designed to emulate a multiprocessor system. Further, the processor(s) 110 may be implemented using a number of heterogeneous data processing systems 100 in which a main processor 110 is present with secondary processors on a single chip. As another illustrative example, the processor(s) 110 may be a symmetric multiprocessor system containing multiple processors 110 of the same type.

When the DPS 100 starts up, the associated processor(s) 110 may initially execute program instructions that make up the operating system 124. The operating system 124, in turn, may manage the physical and logical resources of the DPS 100. These resources may include the main memory 112, the mass storage interface 114, the terminal/display interface 116, the network interface 118, and the system bus 122. As with the processor(s) 110, some DPS 100 embodiments may utilize multiple system interfaces 114, 116, 118, 120, and buses 122, which in turn, may each include their own separate, fully programmed microprocessors.

Instructions for the operating system 124 and/or application programs 126 (generically, “program code,” “computer usable program code,” or “computer readable program code”) may be initially located in the mass storage devices, which are in communication with the processor(s) 110 through the system bus 122. The program code in the different embodiments may be embodied on different physical or tangible computer-readable media, such as the memory 112 or the mass storage devices. In the illustrative example in FIG. 1, the instructions may be stored in a functional form of persistent storage on the direct access storage device 140. These instructions may then be loaded into the main memory 112 for execution by the processor(s) 110. However, the program code may also be located in a functional form on the computer-readable media, such as the direct access storage device 140 or the readable/writable optical disk drive 142, that is selectively removable in some embodiments. It may be loaded onto or transferred to the DPS 100 for execution by the processor(s) 110.

With continuing reference to FIG. 1, the system bus 122 may be any device that facilitates communication between and among the processor(s) 110; the main memory 112; and the interface(s) 114, 116, 118, 120. Moreover, although the system bus 122 in this embodiment is a relatively simple, single bus structure that provides a direct communication path among the system bus 122, other bus structures are consistent with the present disclosure, including without limitation, point-to-point links in hierarchical, star or web configurations, multiple hierarchical buses, parallel and redundant paths, etc.

The main memory 112 and the mass storage device(s) 140 may work cooperatively to store the operating system 124, the application programs 126, and the program data 128. In some embodiments, the main memory 112 may be a random-access semiconductor memory device (“RAM”) capable of storing data and program instructions. Although FIG. 1 conceptually depicts that the main memory 112 as a single monolithic entity, the main memory 112 in some embodiments may be a more complex arrangement, such as a hierarchy of caches and other memory devices. For example, the main memory 112 may exist in multiple levels of caches, and these caches may be further divided by function, such that one cache holds instructions while another cache holds non-instruction data that is used by the processor(s) 110. The main memory 112 may be further distributed and associated with a different processor(s) 110 or sets of the processor(s) 110, as is known in any of various so-called non-uniform memory access (NUMA) computer architectures. Moreover, some embodiments may utilize virtual addressing mechanisms that allow the DPS 100 to behave as if it has access to a large, single storage entity instead of access to multiple, smaller storage entities (such as the main memory 112 and the mass storage device 140).

Although the operating system 124, the application programs 126, and the program data 128 are illustrated in FIG. 1 as being contained within the main memory 112 of DPS 100a, some or all of them may be physically located on a different computer system (e.g., DPS 100b) and may be accessed remotely, e.g., via the network 106, in some embodiments. Moreover, the operating system 124, the application programs 126, and the program data 128 are not necessarily all completely contained in the same physical DPS 100a at the same time, and may even reside in the physical or virtual memory of other DPS 100b.

The system interfaces 114, 116, 118, 120 in some embodiments may support communication with a variety of storage and I/O devices. The mass storage interface 114 may support the attachment of one or more mass storage devices 140, which may include rotating magnetic disk drive storage devices, solid-state storage devices (SSD) that uses integrated circuit assemblies as memory to store data persistently, typically using flash memory or a combination of the two. Additionally, the mass storage devices 140 may also comprise other devices and assemblies, including arrays of disk drives configured to appear as a single large storage device to a host (commonly called RAID arrays) and/or archival storage media, such as hard disk drives, tape (e.g., mini-DV), writable compact disks (e.g., CD-R and CD-RW), digital versatile disks (e.g., DVD, DVD-R, DVD+R, DVD+RW, DVD-RAM), holography storage systems, blue laser disks, IBM Millipede devices, and the like. The I/O interface 120 may support attachment of one or more I/O devices, such as a keyboard 181, mouse 182, modem 183, or printer (not shown)

The terminal/display interface 116 may be used to directly connect one or more displays 180 to the data processing system 100. These displays 180 may be non-intelligent (i.e., dumb) terminals, such as an LED monitor, or may themselves be fully programmable workstations that allow IT administrators and users to communicate with the DPS 100. Note, however, that while the display interface 116 may be provided to support communication with one or more displays 180, the computer systems 100 does not necessarily require a display 180 because all needed interaction with users and other processes may occur via the network 106.

The network 106 may be any suitable network or combination of networks and may support any appropriate protocol suitable for communication of data and/or code to/from multiple DPS 100. Accordingly, the network interfaces 118 may be any device that facilitates such communication, regardless of whether the network connection is made using present-day analog and/or digital techniques or via some networking mechanism of the future. Suitable networks 106 include, but are not limited to, networks implemented using one or more of the “InfiniBand” or IEEE (Institute of Electrical and Electronics Engineers) 802.3x “Ethernet” specifications; cellular transmission networks; wireless networks implemented one of the IEEE 802.11x, IEEE 802.16, General Packet Radio Service (“GPRS”), FRS (Family Radio Service), or Bluetooth specifications; Ultra-Wide Band (“UWB”) technology, such as that described in FCC 02-48; or the like. Those skilled in the art will appreciate that many different network and transport protocols may be used to implement the network 106. The Transmission Control Protocol/Internet Protocol (“TCP/IP”) suite contains a suitable network and transport protocols.

### Cloud Computing

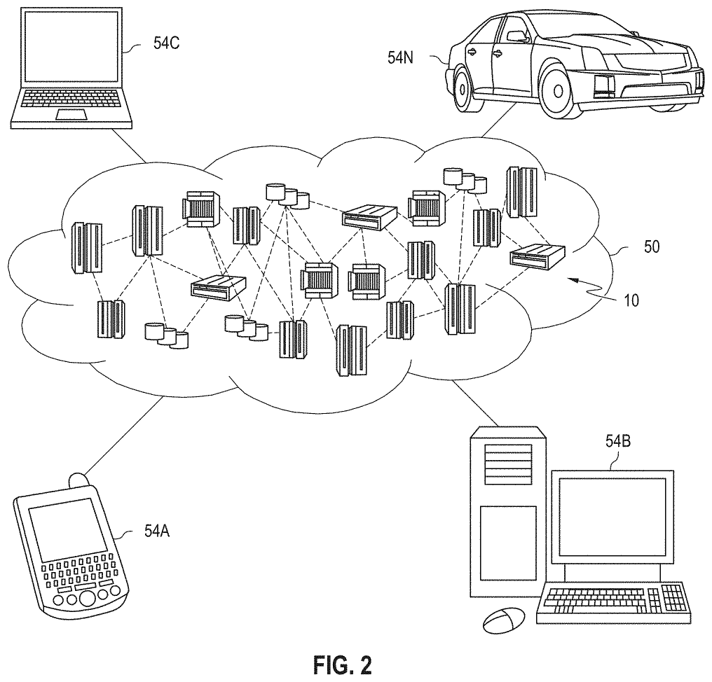

FIG. 2 illustrates one embodiment of a cloud environment suitable for an edge enabled scalable and dynamic transfer learning mechanism. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

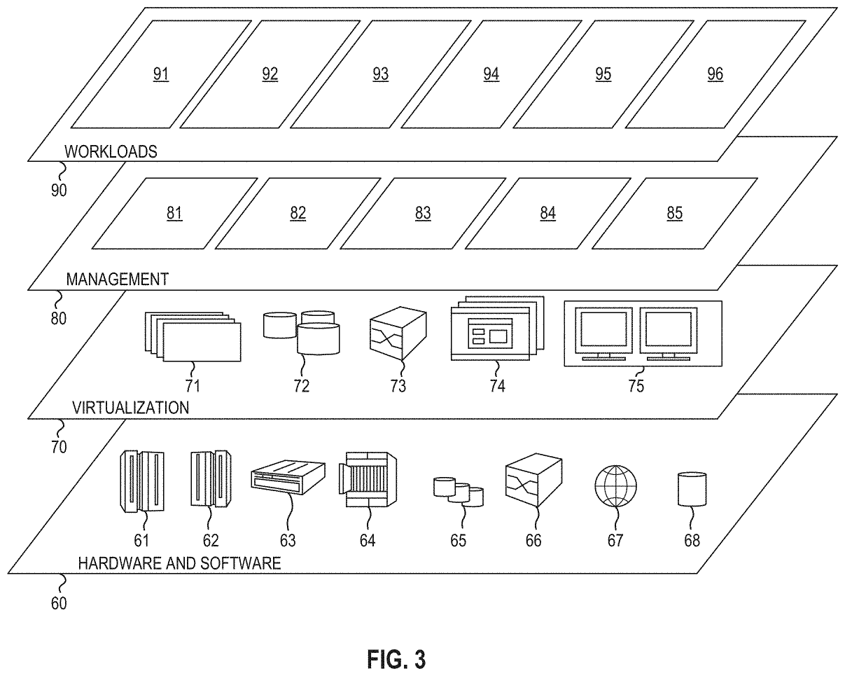

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and virtual assistant (VA) 96.

### Example IoT System

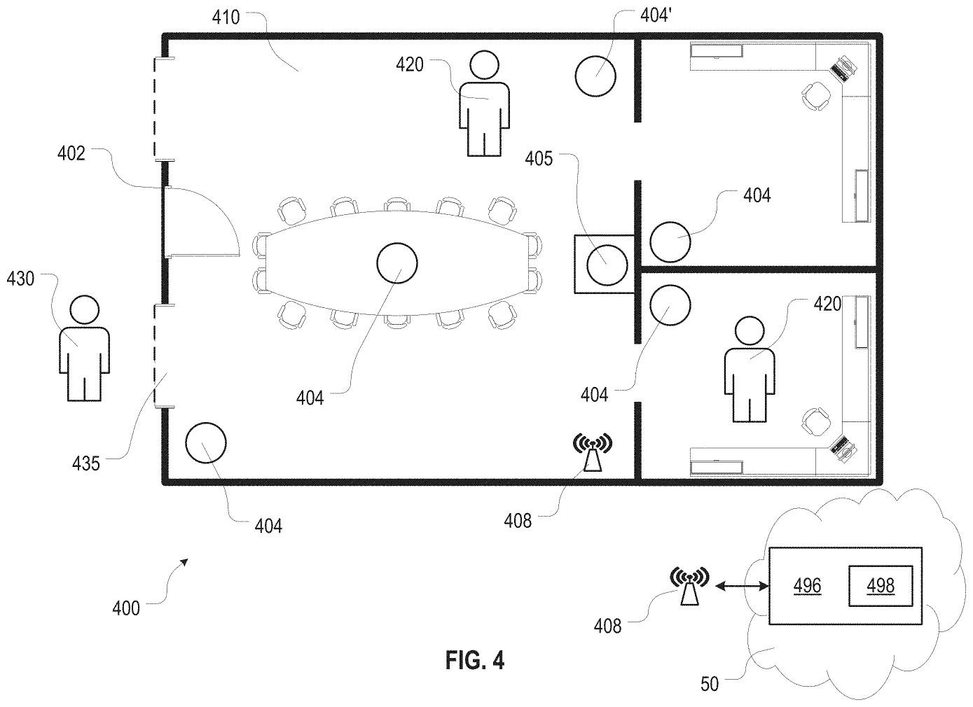

FIG. 4 illustrates an example IoT system 400, consistent with some embodiments. The system 400 in FIG. 4 may comprise a network controllable door lock 402 that controls access into a secure location 410 (e.g., a workspace), a plurality of primary IoT devices 404 (smart speakers, smart watches, smart phones, occupancy sensors, smart power plugs, etc.) located at a plurality of locations throughout the workspace 410, a secure IoT device 405 located in a locked box within the workspace 410, a wireless network hub 408 that connects the plurality of IoT devices 404, 405 to a VA 496 executing in a cloud environment such as the cloud environment 50 described in more detail with reference to FIGS. 1-3. In this example, a plurality of employees 420 are authorized to actuate the lock 402 and enter the workspace 410, and an intruder 430 is trying to illicitly access to the workspace 410 by shining a laser through a window 435.

In operation, one of the employees 420 in the workspace 410 may issue an authorized command to the VA 496. That command may be primarily received by the VA 496 via a closest one of the primary IoT devices 404′. In response, the VA 496 may ping (e.g., communicate with other nearby IoT device(s) 404, 405 for the volume level(s) and/or timestamps(s) at which those other IoT device(s) 404, 405 also received (i.e., overheard) the command. The VA 496 may then calculate the relative volumes and delays at which those other IoT devices 404, 405 received the command, relative to the closest IoT device 404′. Initially, the VA 496 may use this information to train a customized AI model 498 to predict the volume and timing of commands issued at various locations inside this particular workspace 410 as received by the plurality of IoT devices 404, 405. This customized AI model 498 may be trained and/or improved over time to identify anomalous commands e.g., identify commands issued by someone other than employees 420 inside the workspace 410. This model 498 may also be customized based on the content of the command e.g., commands to perform certain actions may be more likely to be spoken in certain parts of the workspace 410 than in others.

After the AI model 498 has been trained, it may be deployed as a security system. Sometime later, an intruder 430 may try to gain access to the workspace 410. This may include shining a laser beam onto one of the IoT devices 404′ to simulate a command initiated from within the workspace 410. In response to receipt of this simulated command, the VA 496 in some embodiments may automatically ping other nearby IoT devices 404, 405, which will report that they did not detect any audio. The AI model 498 may use this additional information to conclude that the simulated command was not real/authorized e.g., that an intruder 430 is trying to gain authorized access to the workspace 410. In some embodiments, ameliorative action will then be taken. This may include automatically alerting an owner of the workspace 410 and/or asking the owner to confirm the initial determination of the AI model 498. In some embodiments, the AI model 498 may use the owner's feedback as additional training corpus, thereby improving its accuracy over time.

Some embodiments may be able to identify an attack from an intruder 430 even if that intruder 430 uses multiple light beams against multiple IoT devices 404. In these embodiments, even though multiple IoT devices 404 may be triggered by light beams, differences in the resulting audio signature (e.g., the relative volumes and/or audio delays of the fake command) may not match those of genuine commands made inside the workspace 410. In this way, these embodiments may conclude that the command is part of an attack and perform ameliorative actions.

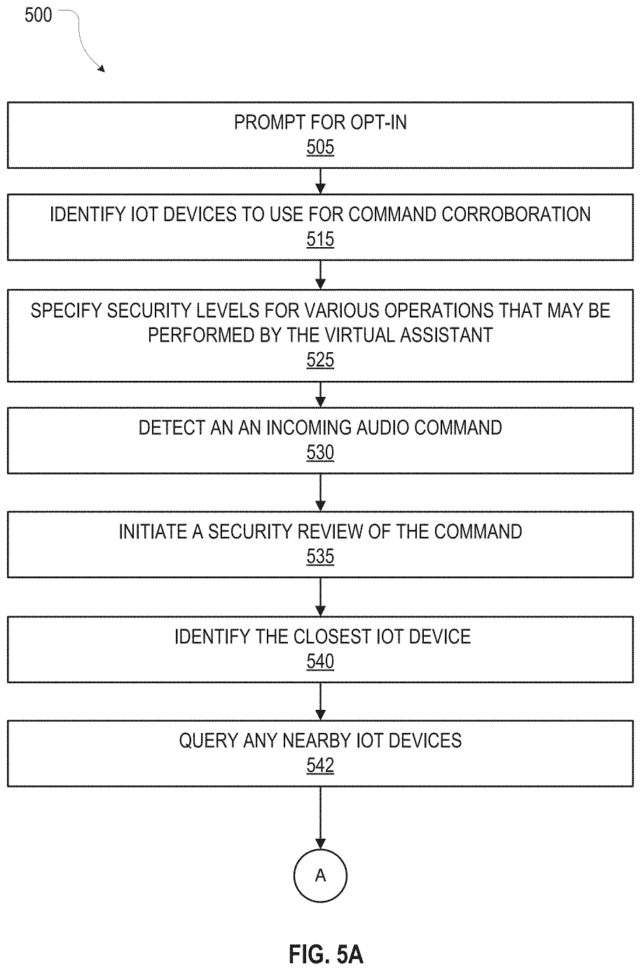

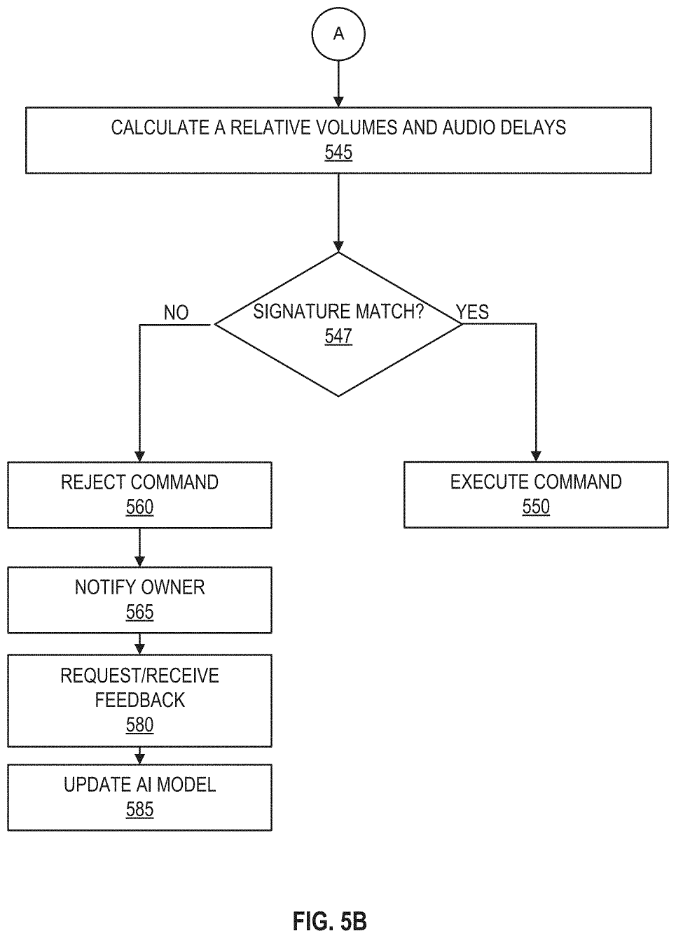

FIGS. 5A-5B are a flow chart illustrating one method 500 of operating the system 400 of FIG. 4. At operation 505, the system 400 may prompt the owner of the workspace 410 and the authorized employees 420 to opt-in to use of the disclosed system 400. This approval may be limited to a specific subset of employees 420 authorized to the workspace 410 and/or to the company's VA 496, or may include all employees 420 who potentially may enter the workspace 410. Next, the system 400 may prompt the owner of the workspace 410 to identify one or more IoT devices 404, 405 to use for command corroboration at operation 515. In some embodiments, this may include the system 400: (i) receiving designations of “n” number of relatively-adjacent IoT devices 404, 405 with microphone capabilities from an owner through a web based portal; or (ii) requesting a list of devices associated with a common network structure/configuration e.g., to designate all IoT devices 404, 405 connected to the same wireless network hub 408 as being adjacent. In some embodiments, this operation 515 may include using the historical corpus to calculate clusters of adjacent of IoT devices 404, 405 using the relative volume levels and audio delays. The designated groups of IoT devices 404, 405 may then be stored in a decentralized network (e.g., a mesh architecture created using an IEEE 802.15.4-based specification) or centralized network (e.g., a client-server architecture) at operation 520.

At operation 525, the system 400 may display a user interface in which the owner can specify security levels for various operations that may be performed by the VA 496. In some embodiments, these security levels may be user-defined per action type. For example, a command to open the lock 402 or to transfer money may be designated as requiring a high level of security than a command asking for the current time. Additionally or alternatively, these security levels may be user-defined per application. For example, all commands related to a smart cash register may be designated as requiring high security, whereas all commands relating to a smart television may be designated as only needing low security.

Next, at operation 530, the system 400 may detect an event. The event may be one of the IoT devices 404′ detecting an incoming audio command requesting a specific action by the VA 496. In response, the VA 496 may initiate a security review of the command at operation 535. In some embodiments, this security review may trigger only when the command is associated with a security level greater than a threshold. In other embodiments, the security review may be performed on all commands. A decision by the VA 496 to perform the requested action may depend on a calculated confidence level that the audio command is authorized e.g., that the command was spoken from within the workspace 410.

In response to an event requiring security review, the system 400 may first identify the closest IoT device 404′ (e.g., the first IoT device 404 to receive the command) at operation 540. The system 400 may then activate and query any nearby IoT devices 404, 405 to the closest IoT device 404′ at operation 542. This operation 542 may include using the configuration information specified in and/or calculated in operation 515. The query may request a measured volume of command at each of the nearby IoT devices 404, 405 and/or a time stamp at which the IoT device 404, 405 received the command. The measured volumes and/or timestamps may then be used to calculate a relative volume and/or audio delay (e.g., volume/timestamp for the command as received by the closest IoT device 404′ minus the volume/timestamp for command as received by each other IoT device 404, 405) at operation 545.

If the VA 496 determines an audio signature for the command matches an expected norm (e.g., the relative volumes and timestamps all fit within an expected threshold, as per a median command received by the closest IoT device 404′), then the VA 496 in some embodiments may conclude that the command originated from within the workspace 410 and then execute the command normally at operations 547 and 550. That is, if the command is also “heard” by the nearby device(s) 404, 405, then some embodiments may mark the given command as not likely due to a beam-forming attack and most likely secure.

Additionally or alternatively, some embodiments may use the customized AI model 498 to evaluate whether or not the relative volumes and audio delays of the command are consistent with an authorized command made from within the workspace 410. That is, the AI model 498 may generate a signature for various commands to make a decision on whether a particular command is authorized or an attack. The signature, in turn, may allow each IoT device 404, 405 to account towards or building towards a given confidence threshold. The weight of each device, in turn, may be weighted by the content of command relative to where it was first received. For example, commands to open a door may be common/expected in certain rooms within the workspace 410 and less common/expected in others. Embodiments that use a signatures may be desirable in the event that multiple beam-forming attacks occur simultaneously on multiple validating IoT devices 404′, as it may be more difficult for an intruder 430 to both activate multiple IoT devices 404 and get all of the relative volumes and timings to match an authorized command.

If the signature does match at operation 547, then the VA 496 may conclude that the command to be “suspicious” (e.g., reasonably likely to be part of a light command based attack). In response, the VA 496 may initially reject the command at operation 560. Ameliorative action may then be taken. This may include notifying the owner in real-time about the potential attack at operation 565. This may include transmitting an electronic message to the owner via mobile notification techniques so that the owner can take immediate action in response to the potential attack or false classification. Some embodiments may also allow the owner to give feedback on the assessment of the VA 496 (e.g., intentional command, suspicious command, etc.) at operation 580.

At operation 585, the feedback may be used to update (e.g., further train) the AI model 498. For example, feedback that a command was an intentional command may serve as negative feedback to the learning loop of the AI model 498, and may cause the system 400 to reanalyze the audio profile of a command across multiple IoT devices 404, 405 to re-evaluate and update the expected audio profile thresholds. This reanalyzing, in turn, may increase the accuracy of the system 400 over time. Feedback that a command was a suspicious command may serve as positive reinforcement to the learning loop of the AI model 498 and may also corroborate the system-generated response when desired. If the owner does not provide feedback, then there may be a strong chance that the command was not intentional, thus providing more positive reinforcement.

### AI Model

In some embodiments a plurality of decentralized or centralized IoT devices 404, 405 may be present in a workspace 410. Whenever one of the IoT devices 404 receives a command at time “T” via audio, some embodiments may responsively query all other IoT devices 404, 405 on the network from time T−1 to monitor for the overheard audio command. After “n” number of such instances, an audio profile may be built. This audio profile may allow some embodiments to begin to find the overlap of devices, their locations, and expected overheard audio as an order of magnitude with each other. This may be plotted and/or modeled exponentially in some embodiments.

The relative magnitudes of the signals received at the various IoT devices 404, 405 may be captured to create a baseline audio signature. For example, the VA 496 may learn that it normally hears commands originating in a first room of the workspace 410 of a first IoT device 404 at 20 decibels, and on a second IoT device 404 at 15 decibels. Similarly, the data corpus may be used to generate a profile of the various background noises within the workspace 410. For example, the VA 496 may learn that it usually hears audio originating from a television in the workspace 410 on a first IoT device 404 at 20 decibels and on a second IoT device 404 at 15 decibels. After many such queries are run, the AI model 498 may begin to calculate guide rails for what an expected audio interaction may be.

The AI models 498 in some embodiments may be any software system that recognizes patterns. In some embodiments, the AI models 498 may comprise a plurality of artificial neurons interconnected through connection points called synapses or gates. Each synapse may encode a strength of the connection between the output of one neuron and the input of another. The output of each neuron, in turn, may be determined by the aggregate input received from other neurons that are connected to it, and thus by the outputs of these “upstream” connected neurons and the strength of the connections as determined by the synaptic weights.

The AI models 498 may be trained to solve a specific problem (e.g., identifying whether or not a command is part of an attack) by adjusting the weights of the synapses such that a particular class of inputs produce a desired output. This weight adjustment procedure in these embodiments is known as “learning.” Ideally, these adjustments lead to a pattern of synaptic weights that, during the learning process, converge toward an optimal solution for the given problem based on some cost function.

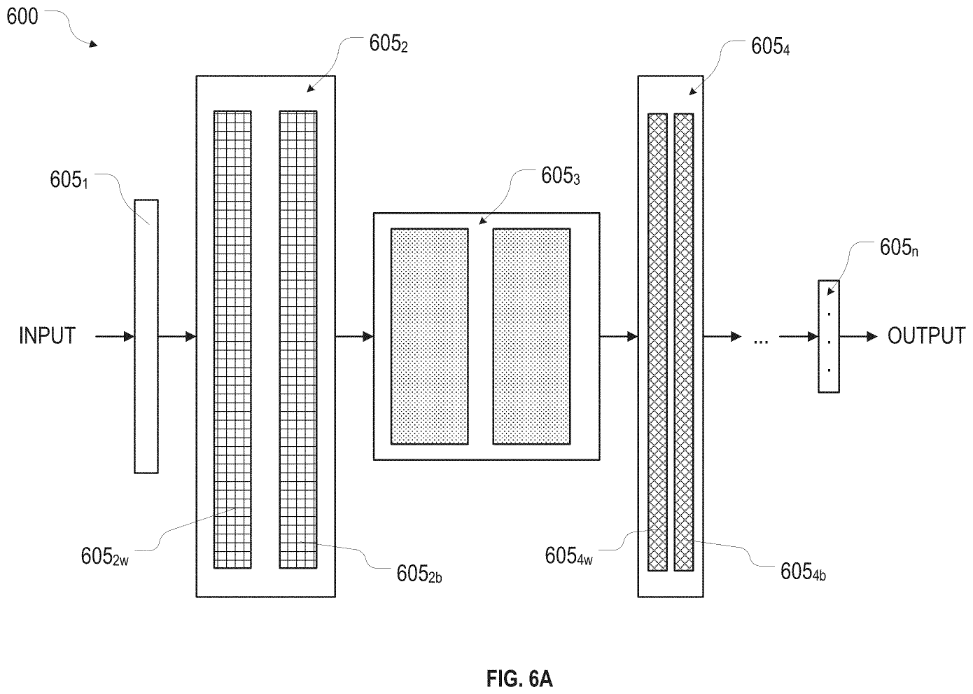

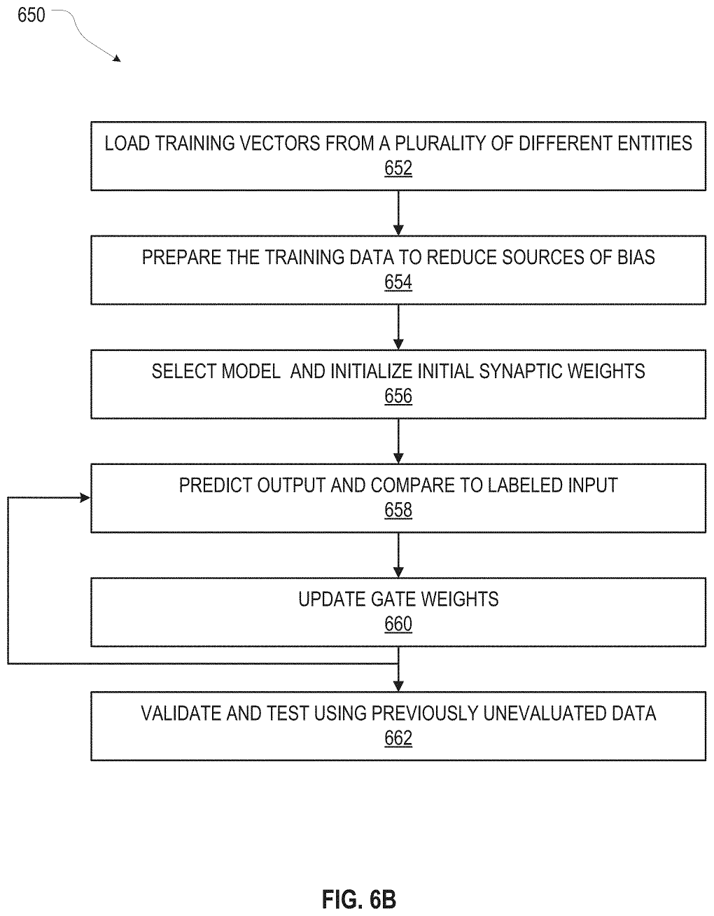

In some embodiments, the artificial neurons may be organized into layers. FIG. 6A illustrates an example AI model 498, consistent with some embodiments. The AI models 498 in FIG. 6A comprises a plurality of layers 605₁-605ₙ. Each of the layers comprises weights 605_{1w}-605_{nw} and biases 605_{1b}-605_{nb} (only some labeled for clarity). The layer 605₁ that receives external data is the input layer. The layer 605ₙ that produces the ultimate result is the output layer. Some embodiments include a plurality of hidden layers 605₂-605ₙ₋₁ between the input and output layers, and commonly hundreds of such hidden layers. Some of the hidden layers 605₂-605ₙ₋₁ may have different sizes, organizations, and purposes than other hidden layers 605₂-605ₙ₋₁. For example, some of the hidden layers in the AI models 498 may be convolution layers, while other hidden layers may be fully connected layers, deconvolution layers, or recurrent layers.

Referring now to FIG. 6B, one embodiment of a AI model training method 650 is depicted. At operation 652, the system receives and loads training data. In this example, the input data-set may include a series of commands recorded in a particular workspace 410 by a plurality of IoT devices 404, 405. At operation 654, the training data is prepared to reduce sources of bias, typically including de-duplication, normalization, and order randomization. At operation 656, an AI model is selected for training and the initial synaptic weights are initialized (e.g., randomized). Depending on the underlying task, suitable models include, but are not limited to, feedforward techniques (e.g., convolutional neural networks), regulatory feedback-based systems, radial basis function (RBF) techniques, and recurrent neural network-based techniques (e.g., long short-term memory). At operation 658, the selected AI model is used to predict an output using the input data element, and that prediction is compared to the corresponding target data. A gradient (e.g., difference between the predicted value and the target value) is then used at operation 660 to update the synaptic weights. This process repeats, with each iteration updating the weights, until the training data is exhausted, or the model reaches an acceptable level of accuracy and/or precision. At operation 662, the resulting model may optionally be compared to previously unevaluated data to validate and test its performance.

### Additional Sensor Inputs

While this disclosure has been described with reference to certain illustrative examples, other embodiments are within its scope and spirit. For example, some embodiments may leverage other types of sensors, such as light sensors, to help identify attacks. Some of these embodiments may track luminosity to detect changes in luminosity at specific wavelengths. If a light of a certain wavelength is detected (all red, blue, green . . . ), then this detected change may help some embodiments determine that the command was not authorized. Similarly, some embodiments may utilize sensors adapted to identify polarized light entering the workspace 410 and/or hitting one of the IoT devices 404.

Some embodiments may monitor additional “bands” of control. For example, some embodiment may utilize for heat signatures to detect physical presence, facial recognition, badge access logs, and/or the presence/absence other background sounds (e.g., walking, breathing, . . . ) to provide a “signature” of the presence, or absence of an authorized user.

Additionally, some embodiments analyze interior configurations (e.g., door open vs. closed, air-conditioning on vs. off, etc.). For example, AI model 498 in some embodiments may leverage a plurality of IoT devices (e.g., an IoT door lock, an IoT thermostat, etc.) in the workspace 410 to detect changes to various interior configurations, and to analyze their impact to the expected audio profile of commands received at the other IoT devices 404, 405. Some of these embodiments may further be able to query those IoT devices, and then digitally subtract their effect from the collected sound profiles in the historical corpus.

### Computer Program Product

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### General

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

Therefore, it is desired that the embodiments described herein be considered in all respects as illustrative, not restrictive, and that reference be made to the appended claims for determining the scope of the invention.

What is claimed is:

1. A method for preventing attacks of audio-based virtual assistants, comprising:
receiving an audio command at a first Internet-of-Things (IoT) device in a location;
analyzing the audio command using one or more other IoT devices in the location, wherein the analyzing includes comparing the audio command received by the first IoT device to audio received by the one or more other IoT devices; and
performing an ameliorative action in response to an anomaly identified during the analyzing.

2. The method of claim 1, wherein the comparing comprises computing a relative volume level.

3. The method of claim 2, wherein the comparing further comprises computing an audio delay.

4. The method of claim 1, wherein the analyzing is in response to a receipt of the audio command by the first IoT device.

5. The method of claim 1, wherein the ameliorative action comprises delaying processing of the audio command.

6. The method of claim 5, wherein the ameliorative action further comprises sending an alert.

7. The method of claim 1, wherein the ameliorative action comprises:
not processing, at a first time, the audio command;
receiving feedback about the identified anomaly; and
in response to the feedback, processing, at a second time subsequent to the first time, the audio command.

8. The method of claim 7, further comprising:
receiving a historical data corpus of audio commands from the first IoT device and the one or more other IoT devices; and
training an artificial intelligence model from the historical corpus to analyze the audio command.

9. The method of claim 8, further comprising using the feedback to further train the artificial intelligence model.

10. The method of claim 1, further comprising identifying the one or more other IoT devices.

11. The method of claim 10, wherein the identifying comprises receiving a user selection of the one or more other IoT devices.

12. The method of claim 10, wherein the identifying comprises analyzing a historical data corpus to identify the one or more other IoT devices.

13. The method of claim 1, further comprising determining a security level for the command; and wherein the analyzing is performed in response to the security level exceeding a predetermined threshold.

14. The method of claim 1, further comprising:
identifying a change to the location; and
calculating an impact of the change on an expected audio profile of the audio command at the one or more other IoT devices.

15. The method of claim 14, wherein the change is chosen from the group consisting of an opening of a door and an activation of a heating, air-conditioning and ventilation (HVAC) system.

16. The method of claim 1, wherein the identified anomaly comprises detection of a signal on a secondary sensor.

17. The method of claim 16, wherein the signal on the secondary sensor comprises a detection of polarized light entering the location.

18. A system for preventing beam-form attacks of audio-based virtual assistants, comprising:
a processing unit; and
a memory coupled to the processing unit and storing instructions thereon, the instructions, when executed by the processing unit, performing a method for preventing attacks of audio-based virtual assistants, comprising:
receiving an audio command at a first Internet-of-Things (IoT) device in a location;
analyzing the audio command using one or more other IoT devices in the location, wherein the analyzing includes comparing the audio command received by the first IoT device to audio received by the one or more other IoT devices; and
performing an ameliorative action in response to an anomaly identified during the analyzing.

19. The system of claim 18, wherein the processing unit and the memory configured into a cloud computing environment.

20. A computer program product for preventing beam-form attacks of audio-based virtual assistants, the computer program product comprising a computer readable storage medium having program instructions embodied therewith, the program instructions executable by a processor to cause the device to perform a method comprising:
receiving an audio command at a first Internet-of-Things (IoT) device in a location;
analyzing the audio command using one or more other IoT devices in the location, wherein the analyzing includes comparing the audio command received by the first IoT device to audio received by the one or more other IoT devices; and
performing an ameliorative action in response to an anomaly identified during the analyzing.
